(19) United States
(12) Patent Application Publication
(10) Pub. No.: US 2026/0248331 A1
(43) Pub. Date: Aug. 27, 2026

(54) MULTIFUNCTIONAL HANDHELD DEVICE WITH ARC-SHAPED HANDLE STRUCTURE

(71) Applicant: Guangzhou Hairspower Technologies Co., Ltd., Guangzhou (CN)

(72) Inventors: Xiuan XIE, Guangzhou (CN); Jianfeng HE, Guangzhou (CN); Jackie ZHANG, Guangzhou (CN); HuaQiang YANG, Guangzhou (CN); Yan WANG, Guangzhou (CN); MJ HUANG, Guangzhou (CN)

(73) Assignee: Guangzhou Hairspower Technologies Co., Ltd., Guangzhou (CN)

(21) Appl. No.: 19/455,905

(22) Filed: Jan. 22, 2026

(30) Foreign Application Priority Data
Feb. 26, 2025 (CN) 2025102192790
Jan. 7, 2026 (CN) 2026100184737

(51) Int. Cl. A47L 5/24; A45D 20/12; A47L 7/00

(52) U.S. Cl. CPC A47L 5/24; A45D 20/12; A47L 7/0085

(57) ABSTRACT

The present disclosure discloses a multifunctional handheld device with an arc-shaped handle structure, including a handle assembly and a body assembly. The handle assembly includes an inner shell assembly, one end of which is connected to the body assembly and the other end of which is connected to a power supply assembly. The inner shell assembly includes an inner shell upper cover and an inner shell lower cover. Both the inner shell upper cover and the inner shell lower cover are arc-shaped, and the two form a hollow arc-shaped inner shell assembly in a surrounding manner when being enclosed. A cavity of the inner shell assembly forms an arc-shaped air duct. The body assembly includes a main shell body and an air duct accessory. The arc-shaped shell is sleeved on the outside of the inner shell lower cover and is connected to the inner shell lower cover.

### CROSS-REFERENCE TO RELATED APPLICATIONS

The application claims priority to Chinese patent applications No. 2025102192790, filed on Feb. 26, 2025, No. 2026100184737, filed on Jan. 7, 2026, the entire contents of which are incorporated herein by reference.

### TECHNICAL FIELD

The present disclosure relates to the field of hair-drying, hair-sucking and dust-collecting multi-functional devices, in particular to a multi-functional handheld device with an arc-shaped handle structure.

### BACKGROUND

Existing hair-drying and hair-sucking multi-functional devices can perform multiple functions such as hairdressing, shaving, hair drying, hair sucking, and dust collecting by changing different connectors. They are powerful in function and easy to use, and therefore have been enthusiastically sought after by the market.

Although the existing technology for shaving and hair-sucking multi-functional devices has been relatively perfect, there are still certain shortcomings, such as insufficient hair sucking capacity (especially when used for hair sucking, because a dust collection box or a hair collection compartment has a small capacity, the multi-functional devices need to be emptied frequently during large-area cleaning, which affects work efficiency), and insufficient suction power: insufficient motor power makes it difficult to handle deep hair or stubborn dirt, resulting in poor cleaning performance and the like.

The above are the conventional shortcomings of the existing shaving and hair-sucking multi-functional devices. In addition to the above conventional shortcomings, the most significant drawback is that the suction power is insufficient and the noise is too high during use, which greatly affects the using experience.

Therefore, it is necessary to improve the structure of the existing shaving and hair-sucking multi-functional devices to increase shaving and hair-sucking power while reducing noise.

### SUMMARY

To solve the above technical problems, a multifunctional handheld device with an arc-shaped handle structure that offers strong suction power and low noise is proposed.

To achieve the above objectives, the technical solution adopted by the present disclosure is as follows: A multifunctional handheld device with an arc-shaped handle structure includes a handle assembly and a body assembly, where the handle assembly includes an inner shell assembly, one end of which is connected to the body assembly and the other end of which is connected to a power supply assembly, the inner shell assembly includes an inner shell upper cover and an inner shell lower cover, both the inner shell upper cover and the inner shell lower cover are semi-circular arc-shaped, and the two form a hollow cylindrical arc-shaped inner shell assembly in a surrounding manner when are enclosed;
a cavity of the inner shell assembly forms an arc-shaped air duct with an arc radius of 100 mm to 200 mm; and
the body assembly includes a main shell body and an air duct accessory, the main shell body consists of an upper arc-shaped shell and a lower cylindrical hollow structure, the arc-shaped shell is sleeved on the outside of the inner shell lower cover of the handle assembly and is connected to the inner shell lower cover in an attached manner, and the air duct accessory is sleeved into the cylindrical hollow structure;
the air duct accessory is of a T-shaped cylindrical hollow structure with an air intake end and an air outlet end at both ends, the radius of a cross section of the air intake end is greater than that of a cross section of the air outlet end, and the air outlet end is provided below the arc-shaped air duct; and
an inner wall of a tail end of the cylindrical hollow structure extends toward an axial direction, an arc-shaped slit outlet is formed between the tail end and one end of the air outlet end of the air duct accessory, and the width of the slit outlet is 1 mm to 3 mm.

Preferably, a sleeve is sleeved on the outside of the inner shell assembly, and the sleeve is arc-shaped, and is matched with the inner shell assembly.

Preferably, an air inlet is at a rear end of the inner shell assembly, and a power connector is installed in a slot formed by the inner shell upper cover and the inner shell lower cover at a rear end of the air inlet.

Preferably, an annular structure is disposed at a front end of the inner shell lower cover, and a positioning boss is disposed on the main shell body; and the annular structure at the front end of the inner shell lower cover is connected to the positioning boss on the main shell body in a matched manner.

Preferably, the body assembly further includes a body upper cover, the body upper cover is of a semi-circular arc-shaped structure, and a switch button is provided on the body upper cover.

Preferably, the body upper cover is installed above the main shell body in a snap-fitted manner.

Preferably, a strap head is movably connected to the tail end of the cylindrical hollow structure,
an O-shaped steel sheet is installed inside an annular groove of the cylindrical hollow structure, and
the strap head is of a cylindrical hollow structure, and a magnet is installed on the strap head; and
the strap head is connected to the O-shaped steel sheet by mutual attraction through the magnet.

Preferably, a filter screen is sleeved at the air inlet of the inner shell assembly, a front end of the filter screen abuts against the sleeve, and a tail end of the filter screen is fixed to a tail end of the inner shell assembly in a screwed manner by a second O-shaped steel sheet.

The present disclosure has the beneficial effects: in the present disclosure, an arc-shaped handle and an arc-shaped air duct are disposed. The arc-shaped air duct can effectively guide the airflow direction and reduce the generation of turbulence and eddies. Not only are vibration and noise during operation significantly reduced, but also the airflow resistance is optimized, thereby increasing wind speed and wind pressure, and making the hair drying more concentrated and powerful. The arc-shaped handle conforms to the curve of the hand, providing a comfortable and stable grip feeling, reducing fatigue during long periods of operation, and significantly improving the user experience.

### BRIEF DESCRIPTION OF DRAWINGS

FIG. 1 is an overall structural block diagram of a multifunctional handheld device with an arc-shaped handle structure according to the present disclosure;

FIG. 2 is a cross-sectional view of a multifunctional handheld device with an arc-shaped handle structure according to the present disclosure;

FIG. 3 is an exploded view of a multifunctional handheld device with an arc-shaped handle structure according to the present disclosure;

FIG. 4 is a schematic structural diagram of a shaving cutter head assembly of an accessory connector according to the present disclosure;

FIG. 5 is a schematic structural diagram of a brush assembly of an accessory connector according to the present disclosure;

FIG. 6 is a schematic structural diagram of a nail grinding head assembly of an accessory connector according to the present disclosure;

FIG. 7 is a schematic structural diagram of a hair trimming comb assembly of an accessory connector according to the present disclosure;

FIG. 8 is a schematic structural diagram of a combing assembly of an accessory connector according to the present disclosure;

FIG. 9 is a schematic structural diagram of a dust collection assembly of an accessory connector according to the present disclosure; and

FIG. 10 is a schematic structural diagram of a foot hair scissors assembly of an accessory connector according to the present disclosure.

### DETAILED DESCRIPTION OF THE EMBODIMENTS

In order to make the objectives, technical solutions, and advantages of the present disclosure clearer, the present disclosure is further described in detail below with reference to embodiments. However, the scope of protection of the present disclosure is not limited to the specific embodiments described below.

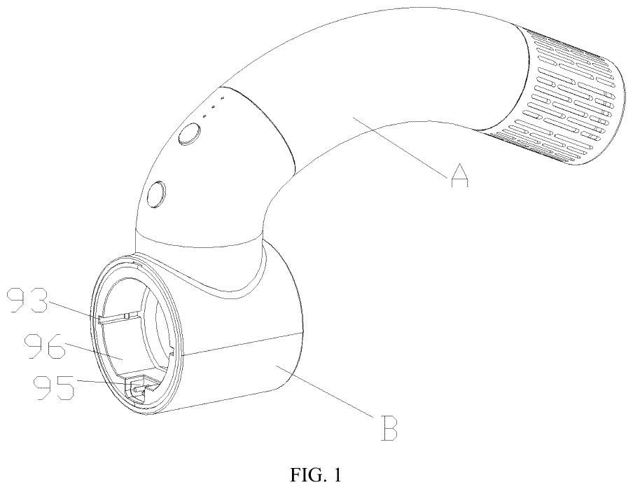

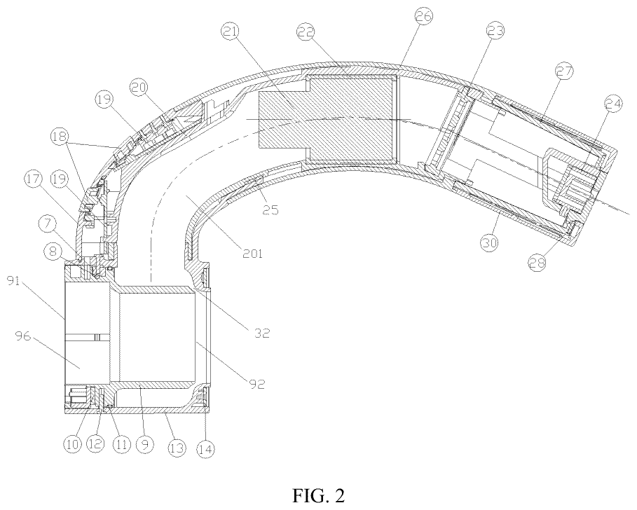

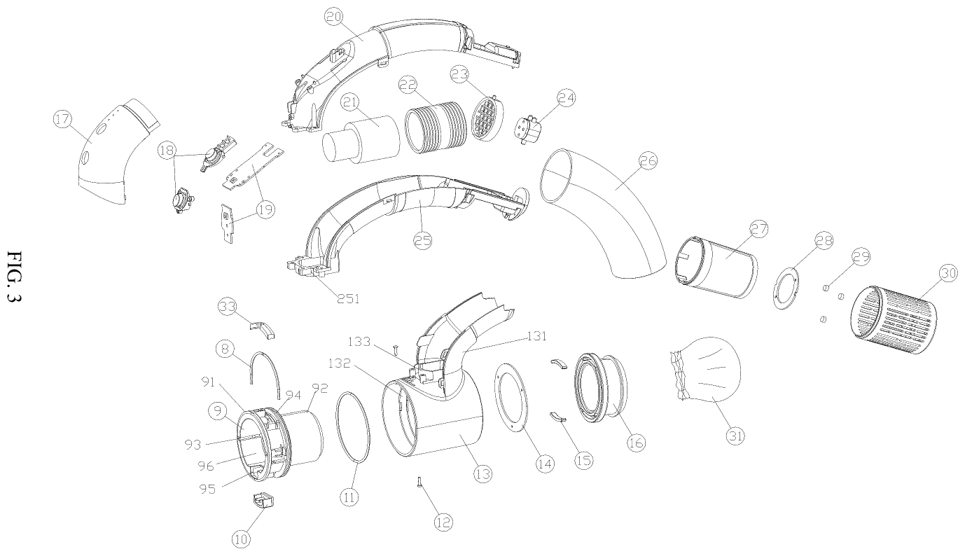

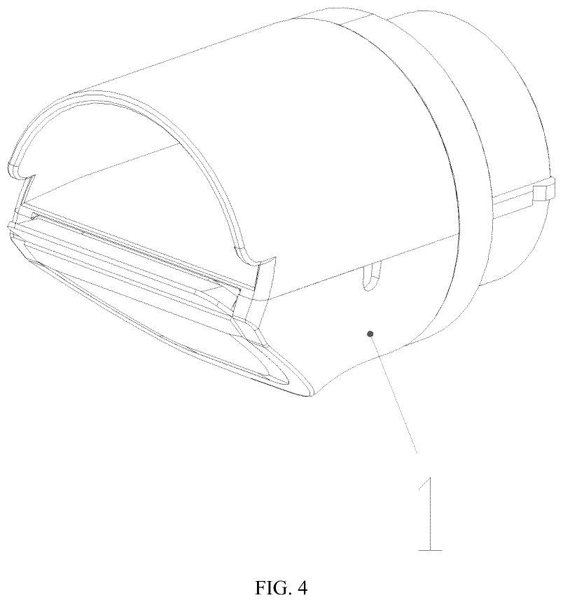

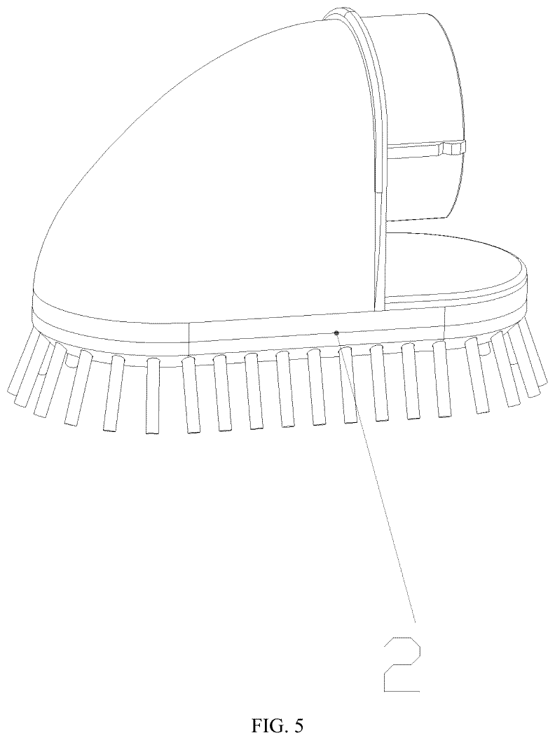

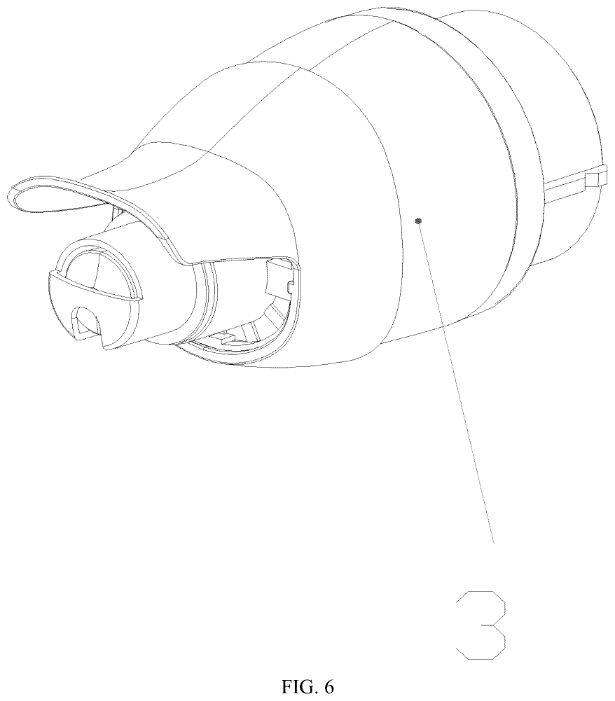

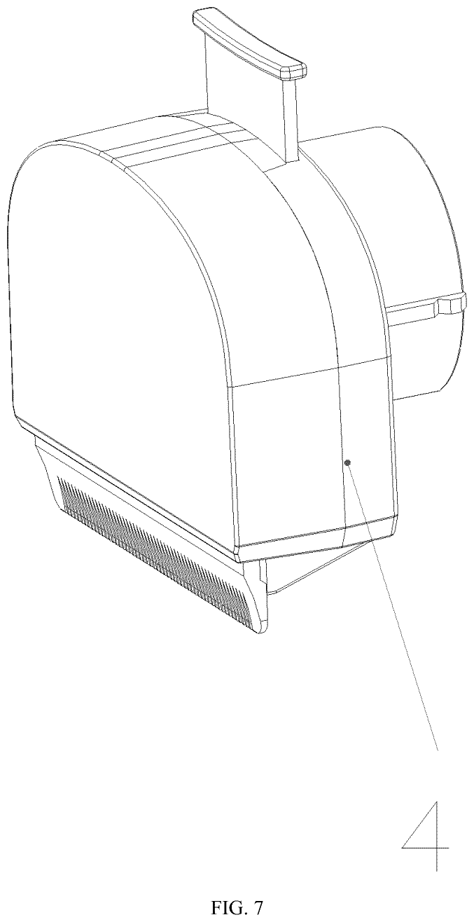

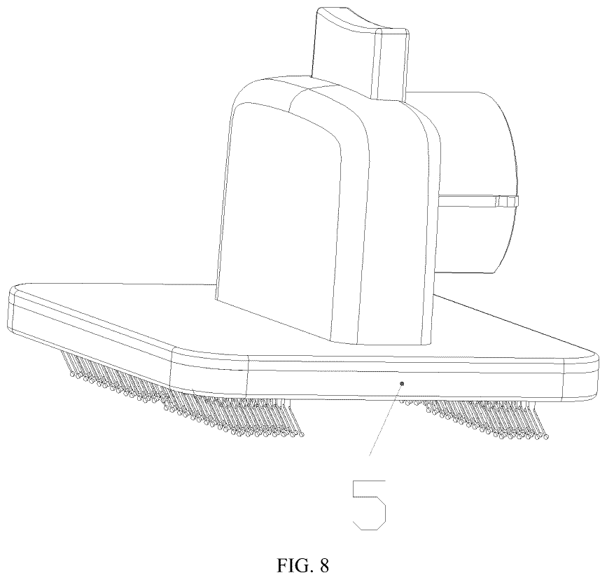

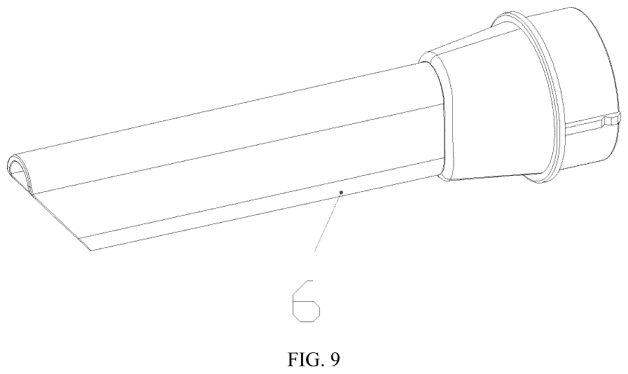

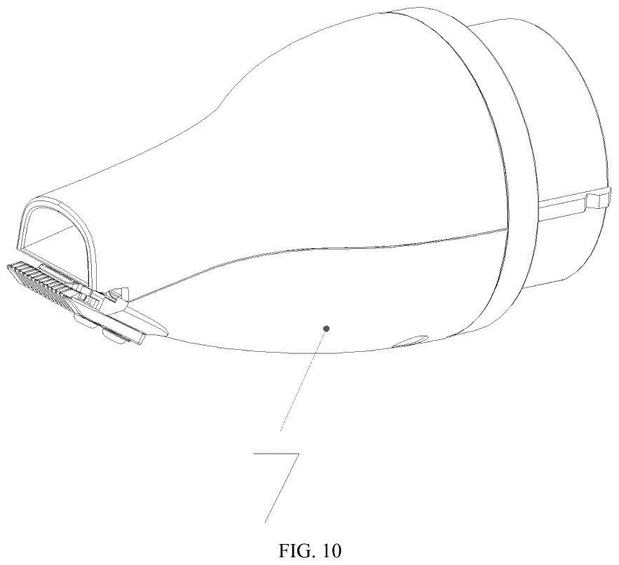

As shown in FIGS. 1-10, a multifunctional handheld device with an arc-shaped handle structure includes a handle assembly A and a body assembly B, where the handle assembly A includes an inner shell assembly, one end of which is connected to the body assembly B and the other end of which is connected to a power connector 24.

Specifically, the inner shell assembly includes an inner shell upper cover 20 and an inner shell lower cover 25. Both the inner shell upper cover 20 and the inner shell lower cover 25 are arc-shaped. The two form a hollow cylindrical arc-shaped inner shell assembly in a surrounding manner when being enclosed. The arc-shaped handle conforms to the curve of the hand, providing a comfortable and stable grip feeling, reducing fatigue during long periods of operation, and significantly improving the user experience.

A cavity of the inner shell assembly forms an arc-shaped air duct 201, the arc radius of the arc-shaped air duct 201 is 100 mm to 200 mm, and the preferred value of the arc radius in this embodiment is 140 mm. The arc-shaped air duct 201 design of the present application, compared with the existing straight-tube design, can smoothly guide the airflow direction, greatly reduce the airflow resistance, make the hair drying more smoothly, and greatly improve the wind power and reduce noise.

The arrangement of the arc-shaped handle assembly A and the arc-shaped air duct 201 presents challenges such as difficulty in mold opening, difficulty in installation and assembly, and inaccurate control of the arc curvature. The present disclosure overcomes the above difficulties by designing an original arc-shaped handle structure and an arc-shaped air duct. The arc-shaped air duct can effectively guide airflow, reduce the generation of turbulence and eddies, significantly reduce vibration and noise during operation, and at the same time, optimize airflow resistance, thereby increasing wind speed and wind pressure, making the hair drying more concentrated and powerful. The arc-shaped handle is designed to conform to the curve of the hand, providing a comfortable grip feeling and reducing fatigue even during long periods of use, thereby enhancing the overall using experience.

The body assembly B includes a main shell body 13 and an air duct accessory 9. The main shell body 13 consists of an upper arc-shaped shell 131 and a lower cylindrical hollow structure 132. The arc-shaped shell 131 is sleeved on the outside of the inner shell lower cover 25 of the handle assembly and is connected to the inner shell lower cover 25 in an attached manner. The air duct accessory 9 is sleeved into the cylindrical hollow structure 132.

Specifically, the air duct accessory 9 is of a T-shaped cylinder hollow structure with an air intake end 91 and an air outlet end 92 at both ends. The radius of a cross section of the air intake end 91 is greater than that of a cross section of the air outlet end 92. The air outlet end 92 is provided below the arc-shaped air duct 201.

An inner wall of a tail end of the cylindrical hollow structure 132 extends toward an axial direction, and an inclined arc-shaped slit outlet 32 is formed between the extended part and one end of the air outlet end of the air duct accessory 9. The width of the slit outlet 32 is 1 mm to 3 mm. The arc-shaped slit outlet 32 is connected to the arc-shaped air duct 201, and the air blown out of the arc-shaped air duct is blown out from the slit outlet.

Guided by the arc-shaped air duct 201, the airflow is accelerated and ejected at the gradually shrinking arc-shaped slit outlet 32. This shrinking structure, while maintaining a stable air output, significantly increases airflow velocity and wind pressure by reducing the outlet cross-sectional area, thereby achieving a more concentrated and powerful hair drying effect.

An electronic control assembly 19 is fixedly disposed at the front end of the outside surface of the inner shell upper cover 20 through a circuit board fixing slot. The electronic control assembly 19 is a control circuit board used to control a high-speed fan or motor.

The high-speed fan 21 is installed at the middle position of the arc-shaped air duct formed by the inner shell upper cover 20 and the inner shell lower cover 25. The high-speed fan 21 is sleeved with a silicone sleeve 22, and the silicone sleeve 22 can effectively absorb the vibration and noise generated by the high-speed fan 21 during operation. A rectifier mesh 23 is also disposed on an air intake rear side of the high-speed fan 21. The rectifier mesh 23 can streamline the airflow, making it enter the high-speed fan 21 more evenly and smoothly. The smooth airflow can improve the working efficiency of fan blades and reduce the eddy noise caused by airflow turbulence.

The inner shell assembly is sleeved with a sleeve 26, and the sleeve 26 is arc-shaped and is matched with the inner shell assembly. The sleeve 26 covers and tightens the inner shell upper cover 20 and the inner shell lower cover 25, making them a whole and effectively preventing them from separating or shifting, thereby improving the rigidity and reliability of the overall structure. The rear end of the inner shell assembly is an air inlet. A power connector 24 is installed at a slot formed by the inner shell upper cover 20 and the inner shell lower cover 25 at a rear end of the air inlet, which is used to connect an external power source to provide power to the device.

A filter screen 27 is sleeved at the air inlet of the inner shell assembly to prevent debris from entering the high-speed fan 21 from the air inlet. A front end of the filter screen abuts against the sleeve 26, and a tail end of the filter screen is fixed to the tail end of the inner shell assembly in a screwed manner by a second O-shaped steel sheet 28. A filter screen shell 30 is of a cylindrical hollow structure with a large open opening at a front end and a semi-open opening at a rear end that is matched with a charging port of the inner shell assembly. Several air inlet slots are evenly opened on a side of the filter screen shell, and a magnet slot for embedding a second magnet 29 is opened at the bottom of the inside of the filter screen shell. The filter screen shell 30 is installed on the filter screen 27 in a covering manner and a second O-shaped steel sheet 28 is attracted by the second magnet 29, forming a quick-release structure through the attraction with the second O-shaped steel sheet 28.

A positioning boss 133 is disposed on the main shell body 13, and an annular structure 251 is disposed at a front end of the inner shell lower cover 25. The inner shell assembly is connected to the positioning boss 133 on the main shell body 13 in a matched manner through the annular structure 251 at the front end of the inner shell lower cover 25, and is installed above the main shell body 13.

The body assembly further includes a body upper cover 17, the body upper cover is a semi-circular arc-shaped structure. The body cover 17 is provided with a switch slot for installing a switch button 18 and a signal light hole for displaying a signal light. The body upper cover 17 is installed above the main shell body 13 and is fixed in a snap-fitted manner.

The air duct accessory 9 is assembled into the cylindrical hollow cavity of the main shell body 13 with its air intake end facing forward, and is fastened by rivets 12. The outer periphery of the air intake end of the air duct accessory 9 and the inner wall of the cylindrical hollow cavity are hermetically matched by O-rings 11.

The tail end of the cylindrical hollow structure 131 is movably installed with a strap head 16 for sleeving a hair storage bag 31. The specific installation method is as follows:

An O-shaped steel sheet 14 is installed in the annular groove on the inner wall at th tail end of the cylindrical hollow structure 131. The strap head 16 is of a cylindrical hollow structure, and a magnet 15 is embedded in the front end of the strap head through a magnet slot. The strap head 16 is detachably installed at the tail end of the cylindrical hollow structure 131 through the mutual attraction between the magnet 15 and the O-shaped steel sheet 14.

In addition, an accessory fixing interface 96 for connecting functional accessories is disposed inside the air intake end of the air duct accessory 9, and guide grooves 93 are symmetrically opened on both sides of the accessory fixing interface 96.

A retaining spring groove 94 is provided above the outside of the air intake end of the air duct accessory 9. The retaining spring groove 94 is communicated to the guide groove 93. A U-shaped retaining spring 8 is installed in the retaining spring groove 94. Two side arms of the U-shaped retaining spring 8 can engage with the retaining spring groove on a functional accessory connector inserted into the guide groove 93 to achieve detachable fixation. A retaining spring pressing plate 33 for limiting the U-shaped retaining spring 8 is disposed above the U-shaped retaining spring 8.

A power connector slot 95 is provided below the front end of the air duct accessory 9, and the power connector slot 95 is communicated to the accessory fixing interface 96 inside. A power connector 10 is fixedly disposed in the power connector slot, and power pins of the power connector pass through the communication part and extend into the inside of the accessory fixing interface 96. At the connection between the large end and the small end of the air duct accessory 9, a sealing ring groove is annularly provided, and the O-ring 11 is assembled into the sealing ring groove.

Specifically, the fixing interface 96 is configured to install various accessory connectors, such as the shaving cutter head assembly 1, the brush assembly 2, the nail grinding head assembly 3, the hair trimming comb assembly 4, the combing assembly 5, the dust collection assembly 6, and the foot hair scissors assembly 7. These accessories are all equipped with an interface structure at the tail ends. The interface structure has symmetrical guide blocks on both sides, and the guide blocks have retaining spring grooves. Below the connector structure, the accessories that require an external power supply are correspondingly provided with power sockets. During installation, the guide block of the connector structure is matched with the guide groove inside the body, and the two side arms of the U-shaped retaining ring 8 engage with the retaining ring groove on the guide block, so that the functional accessories are detachably fixed to the body assembly.

The working principle of the present disclosure is as follows:

When a fan motor is started, a large amount of generated airflow passes through the arc-shaped air duct 201, and is then blown out through the arc-shaped slit outlet 32 formed by the main shell body and the air duct accessory. As the air duct gradually narrows during the process of the gas passing through the arc-shaped slit outlet 32 and then being blown out through the slit, the reduction in the area of the air outlet will lead to an increase in wind speed when the air output is stable. The high-speed airflow blown out from the slit of an air outlet channel is ejected at high speed through the tail end of the main shell body. Due to the fluid dynamics wall adhesion effect, the airflow will flow at high speed along the inner wall of the tail end of the main shell body when it is blown out from the arc-shaped slit outlet 32. According to Bernoulli's principle, the high-speed moving air will generate a negative pressure region (the cavity inside the air duct accessory 9) behind the arc-shaped slit outlet 32. This negative pressure region will draw in the outside air, and then the viscosity of the gas will drive this part of the air to move. During this process, a suction force will be generated at the air intake end (front end) of the air duct accessory, drawing things from the outside into the cavity inside the air duct accessory 9. On the side of an air blowing channel, the total amount of moving air is much greater than that of the high-speed gas blown out from the arc-shaped slit outlet 32. The air blowing channel will blow out a very strong airflow.

The effects of the present disclosure with different accessories according to different application scenarios: A strap head 16 is assembled on the side of the air outlet, and a hair storage bag 31 is sleeved on the strap head. When the shaving cutter head assembly is assembled on an air intake side, the device is a hair suction shaver 1. When trimming hair, the trimmed hair will be sucked into the hair storage bag 31, which can prevent hair from falling to the ground and reduce the user's subsequent hair cleaning work.

When the brush assembly 2 is assembled on the air intake side, the device can be used to remove hair debris and dust from pets, and can also be used to clean carpets and sofas in daily life.

When the combing assembly 3 is assembled on the air intake side, the device can be used to comb the pet's hair daily. During the combing, hair falling from the pets and the dust and sand particles that stick to their bodies when the pets run and roll can be sucked into the hair storage bag 31 through the combing process, keeping the pet's body clean at all times.

When the dust collection assembly 4 is assembled on the air intake side, the device can be used as a dust cleaner.

When the nail grinding assembly 5 is assembled on the air intake side, the device can be used as a dust collection nail grinder. When grinding the pet's nails, the grinding dust can be sucked into the dust collection bag 31, which can prevent the environment from being polluted by dust.

When the hair trimming assembly 6 is assembled on the air intake side, the device can be used as a hair trimming and hair sucking comb. When trimming the pet's hair, the trimmed hair will be sucked into the hair collection bag, which can prevent the hair from falling to the ground and reduce the user's subsequent hair cleaning work.

When the foot hair scissors assembly 7 is assembled on air intake side, the device can be used as a pair of hair suction foot hair scissors. When cleaning the hair between the pet's toes, the trimmed hair will be sucked into the hair collection bag, which can prevent the hair from falling to the ground and reduce the user's subsequent hair cleaning work.

Based on the disclosure and teachings of the above specification, those skilled in the art can also make changes and modifications to the above embodiments. Therefore, the present disclosure is not limited to the specific embodiments disclosed and described above, and some modifications and changes to the invention should also fall within the protection scope of the claims of the present disclosure. Furthermore, although certain terms are used in this specification, these terms are for illustrative purposes only and do not constitute any limitation on the invention.

What is claimed is:

1. A multifunctional handheld device with an arc-shaped handle structure, comprising a handle assembly and a body assembly that are internally communicated with each other, wherein the handle assembly comprises an inner shell assembly, the inner shell assembly is in a hollow cylindrical arc shape and comprises an inner shell upper cover (20) and an inner shell lower cover (25), both the inner shell upper cover (20) and the inner shell lower cover (25) are arc-shaped, and the inner shell upper cover (20) is connected to the inner shell lower cover (25) in a covering manner;
a cavity of the inner shell assembly forms an arc-shaped air duct (201), and the arc radius of the arc-shaped air duct (201) is 100 mm to 200 mm; and
the body assembly comprises a main shell body (13) and an air duct accessory (9), wherein the main shell body (13) comprises an arc-shaped shell (131) and a cylindrical hollow structure (132), the arc-shaped shell (131) is sleeved on an outer wall of the inner shell lower cover (25) of the handle assembly and is connected to the inner shell lower cover (25) in an attached manner, and the air duct accessory (9) is sleeved into the cylindrical hollow structure (132).

2. The multifunctional handheld device with an arc-shaped handle structure according to claim 1, wherein the air duct accessory (9) is of a T-shaped cylindrical hollow structure with an air intake end and an air outlet end at both ends, the radius of a cross section of the air intake end is greater than that of a cross section of the air outlet end, and the air outlet end is provided below the arc-shaped air duct (201).

3. The multifunctional handheld device with an arc-shaped handle structure according to claim 2, wherein an inner wall of a tail end of the cylindrical hollow structure (132) extends toward an axial direction, an arc-shaped slit outlet (32) is formed between the tail end and one end of the air outlet end of the air duct accessory (9), and the width of the slit outlet (32) is 1 mm to 3 mm.

4. The multifunctional handheld device with an arc-shaped handle structure according to claim 1, wherein a sleeve (26) is provided on an outside of the inner shell assembly, and the sleeve (26) is arc-shaped, and is matched with the inner shell assembly.

5. The multifunctional handheld device with an arc-shaped handle structure according to claim 2, wherein an air inlet is at a rear end of the inner shell assembly, and a power connector (24) is installed in a slot formed by the inner shell upper cover (20) and the inner shell lower cover (25) at a rear end of the air inlet.

6. The multifunctional handheld device with an arc-shaped handle structure according to claim 1, wherein an annular structure (251) is disposed at a front end of the inner shell lower cover (25), a positioning boss (133) is disposed on the main shell body (13), and
the annular structure (251) at the front end of the inner shell lower cover (25) is connected to the positioning boss (133) on the main shell body (13) in a matched manner.

7. The multifunctional handheld device with an arc-shaped handle structure according to claim 1, wherein the body assembly further comprises a body upper cover (17), the body upper cover (17) is of a semi-circular arc-shaped structure, a switch button (18) is provided on the body upper cover (17), and
the body upper cover (17) is installed above the main shell body (13) in a snap-fitted manner.

8. The multifunctional handheld device with an arc-shaped handle structure according to claim 1, wherein a strap head (16) is movably connected to a tail end of the cylindrical hollow structure (132);
an O-shaped steel sheet (14) is installed inside an annular groove of the cylindrical hollow structure (132), and
the strap head (16) is of a cylindrical hollow structure, and a magnet (15) is installed on the strap head (16); and
the strap head (16) is connected to the O-shaped steel sheet (14) by mutual attraction through the magnet (15).

9. The multifunctional handheld device with an arc-shaped handle structure according to claim 4, wherein a filter screen (27) is sleeved at the air inlet of the inner shell assembly, a front end of the filter screen (27) abuts against the sleeve (26), and a tail end of the filter screen (27) is fixed to a tail end of the inner shell assembly in a screwed manner by a second O-shaped steel sheet (28).
